(19) United States
(12) Patent Application Publication
(10) Pub. No.: US 2006/0284007 A1
(43) Pub. Date: Dec. 21, 2006

(54) Propeller guard for aircraft

(76) Inventor: Thomas Hawkins, Mountain View, CA (US)

Correspondence Address: Mark Terry, Ste. 500, 2250 SW 3rd Av., Miami, FL, 33129, US

(21) Appl. No.: 11/338,027

(22) Filed: Jan. 24, 2006

Related U.S. Application Data
(60) Provisional application No. 60/647,905, filed on Jan. 28, 2005.

(51) Int. Cl. B64C 11/00; B64C 1/10; B63H 1/16

(52) U.S. Cl. 244/65; 244/121; 416/189

(57) ABSTRACT

A safety device for a fixed wing aircraft includes a strip positioned around propeller blades. In one alternative, the strip has a circular shape and a cross-sectional airfoil shape wherein the strip is coupled with any one of a trailing edge of the fixed wing and a leading edge of the fixed wing. In another alternative, the safety device includes a light coupled -with the strip or integrated in a surface of the strip. In yet another alternative, the safety device for the fixed wing aircraft includes a propeller having blades that rotate and a strip positioned around at least a part of a rotational path of outer tips of the blades when rotating.

### CROSS-REFERENCE TO RELATED APPLICATIONS

The present patent application claims priority to U.S. provisional patent application Ser. No. 60/647,905 filed on Jan. 28, 2005 and entitled “Propeller Guard for Aircraft.” U.S. provisional patent application Ser. No. 60/647,905 is hereby incorporated by reference in its entirety.

### STATEMENT REGAURDING FEDERALLY SPONCERD RESEARCH OR DEVLEOPMENT

Not Applicable.

### INCORPORATION BY REFERENCE OF MATERIAL SUBMITTED ON A COMPACT CISC

Not Applicable.

### FIELD OF THE INVENTION

The invention disclosed broadly relates to the field of aircraft design and more particularly relates to the field of safety design features for aircraft.

### BACKGROUND OF THE INVENTION

The Federal Aviation Administration (FAA) recently instituted a new aircraft certification for Light-Sport Aircraft. Section 1.1 of title 14 of the Code of Federal Regulations (CFR) puts forth the details of the new certification. Light-sport aircraft are simple, low-performance aircraft that are limited to 1,320 lbs. maximum weight, two occupants, a single non-turbine powered engine, stall speed of 45 knots, maximum airspeed of 120 knots, and fixed landing gear. Aircraft categories include airplanes, weight-shift-control aircraft, powered parachutes, gyroplanes, gliders, balloons and airships.

The FAA further instituted a new airworthiness certificate entitled Special Light-Sport Airworthiness Certificate. The details of this certificate are defmed in section 21.190 of title 14 of the Code of Federal Regulations. This new category of special airworthiness certificate is issued to aircraft that are designed and manufactured to an identified standard developed by industry and accepted by the FAA. These aircraft can be used for the following purposes: sport and recreation, flight training, rental and towing.

With regard to certification of pilots and flight instructors to operate light-sport aircraft, the FAA also recently created two new pilot certificates and two new aircraft category ratings to allow operations of light-sport aircraft. The sport pilot certificate and flight instructor certificate with a sport pilot rating are issued without any category and class ratings. Aircraft category, class, and make and model privileges are established through logbook endorsements.

The purpose behind the new FAA certifications is to introduce lightweight recreational aircraft that are geared toward the recreational pilot. It is predicted that this development will result in the spawning of a new industry that services lightweight sport aircraft and recreational pilots. More aircrafts will be seen in the sky and more pilots will be flying. This new development, however, will not come without its drawbacks.

Almost as soon as the new aircraft and pilot certifications emerge, so will safety issues. As a result of the new aircraft certification and the predicted low cost of producing light sport aircraft, there will be more aircraft on the ground and in the air. This leads to traffic issues and problems related to restricting access to aircraft. As a result of the new pilot certification, there will be more and lesser-trained pilots flying these aircraft in the skies. Further, there will be an increased number of novice pilots and their passengers near and around light sport aircraft on the ground. This increases the potential for accidents relating to the interaction between people and potentially dangerous aircraft. The potential for accidents is further compounded by the reduced experience required of the new pilot certification. Additionally, these new aircraft will appear in areas previously not accessible by aircraft like boat marinas, grass fields, etc.

Therefore, a need exists to overcome the problems with the prior art as discussed above, and particularly for a way to introduce more safety features for aircraft.

### SUMMARY OF THE INVENTION

Briefly, according to an embodiment of the present invention, a safety device for a fixed wing aircraft is disclosed. The safety device includes a strip positioned around propeller blades. In one alternative, the strip has a circular shape and a cross-sectional airfoil shape. In another alternative, the strip is coupled with any one of a trailing edge of the fixed wing and a leading edge of the fixed wing. In yet another alternative, the safety device includes a light coupled with the strip or integrated in a surface of the strip.

In another embodiment of the present invention, a safety device assembly for a fixed wing aircraft includes a propeller having blades that rotate and an arc located around the blades. In one alternative, the arc has a cross-sectional airfoil shape. In another alternative, the arc is coupled with any one of a trailing edge of the fixed wing and a leading edge of the fixed wing. In yet another alternative, the safety device includes a light coupled with the arc or integrated in a surface of the arc.

In another embodiment of the present invention, a safety device assembly for a fixed wing aircraft includes a propeller having blades that rotate and a strip positioned around at least part of a rotational path of outer tips of the blades when rotating. In one alternative, the strip has a circular shape and a cross-sectional airfoil shape. In another alternative, the strip is coupled with any one of a trailing edge of the fixed wing and a leading edge of the fixed wing. In yet another alternative, the safety device includes a light coupled with the strip or integrated in a surface of the strip.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration showing an angled view of a light sport aircraft with a propeller guard, in one embodiment of the present invention.

FIG. 2 is an illustration showing another angled view of the aircraft of FIG. 1.

FIG. 3 is an illustration showing a frontal view of the aircraft of FIG. 1.

FIG. 4 is an illustration showing a side view of the aircraft of FIG. 1.

FIG. 5 is an illustration showing a top view of the aircraft of FIG. 1.

FIG. 6 is a drawing showing a more detailed angled view of a propeller guard, in one embodiment of the present invention.

FIG. 7 is a drawing showing another angled view of the propeller guard of FIG. 6.

FIG. 8 is a drawing showing a side view of the propeller guard of FIG. 6.

FIG. 9 is a drawing showing a top view of the propeller guard of FIG. 6.

FIG. 10 is a drawing showing a frontal view of the propeller guard of FIG. 6.

FIG. 11 is a drawing showing a rear view of the propeller guard of FIG. 6.

FIG. 12 is an illustration showing various aerodynamic cross-sectional shapes for the propeller guard, in one embodiment of the present invention.

### DETAILED DESCRIPTION

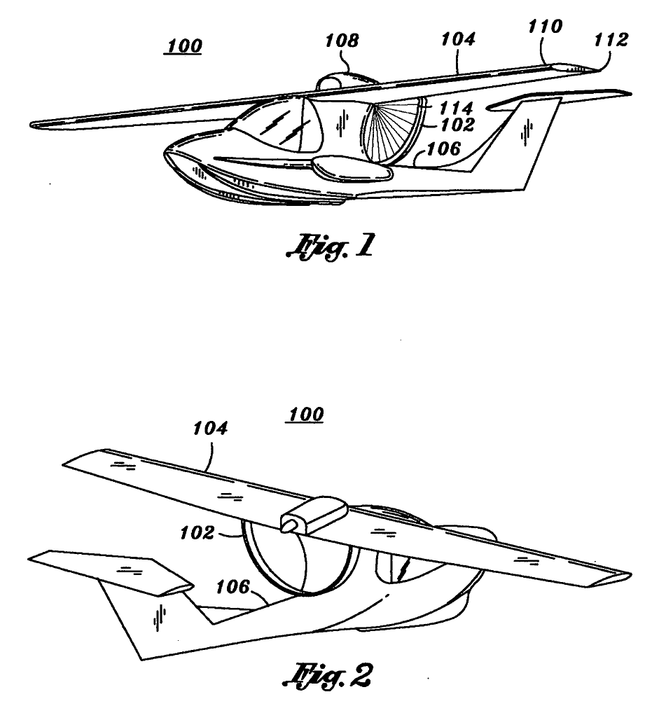

FIG. 1 is an illustration showing an angled view of a light sport aircraft 100 with a propeller guard 102, in one embodiment of the present invention. FIG. 1 shows the aircraft 100 including a fixed wing 104 having a leading edge 110 and a trailing edge 112. The aircraft 100 further includes a propeller 108 including propeller blades (now shown) that rotate. The fuselage 106 of the aircraft 100 is located under the fixed wing 104. A propeller guard 102 is coupled with the fixed wing 104 and the fuselage 106.

The propeller guard 102 comprises a semicircular strip or arc that is positioned outside at least a portion of the circular arc traveled by outer tips of the blades (not shown) of the propeller 108 when rotating. In another embodiment of the present invention, the propeller guard 102 comprises a circular strip or a complete ring that is positioned outside the circular arc traveled by outer tips of the blades of the propeller 108 when rotating. The propeller guard 102 provides a barrier around the outer tips of the blades of the propeller 108 when rotating. The propeller guard 102 protects unsuspecting or unaware bystanders, pilots, passengers and mechanics from contacting the outer tips of the propeller blades and incurring injuries. The propeller guard 102 further protects the propeller blades from contacting other objects such as portions of other aircraft, trees, hangar doors, or luggage. For a seaplane equipped with the propeller guard 102, the guard protects the propeller blades from contacting docks, boats and other marine equipment.

FIG. 1 shows that the propeller guard 102 is positioned to surround at least a portion of the circular arc traveled by the outer tips of the blades of the propeller 108, which is positioned at the center of the fixed wing 104. It should be noted that the present invention supports the positioning of the propeller 108 anywhere on the fixed wing 104, whether the propeller 108 is positioned in the center of the fixed wing 104, off-center of the fixed wing 104, on one side of the fixed wing 104, or on a tip of the fixed wing 104. Likewise, the present invention supports the propeller guard 102 being positioned so as to completely or partially surround the blades of the propeller 108 in any of the aforementioned positions. Further, FIG. 1 shows that the propeller 108 is positioned so that the propeller blades operate off of the trailing edge 112 of the fixed wing 104. Hence the propeller guard 102 is positioned on the trailing edge 112 of the fixed wing 104. It should be noted that the present invention also supports the positioning of the propeller 108 on the leading edge 110 of the fixed wing 104. The present invention further supports the positioning of the propeller guard 102 anywhere a propeller 108 is located on the aircraft 100.

FIG. 1 further shows an array of rods or shafts 114 that extend radially outward from the position of the propeller 108, in one embodiment of the present invention. In this embodiment, the array of shafts 114 is coupled on one end to the trailing edge 112 of the fixed wing 104 or to the propeller 108. The array of shafts 114 is coupled on the other end to the leading edge of the propeller guard 102. The shafts 114 may be composed of the same material as the propeller guard 102 and/or the fixed wing 104. The shafts 114 may have a cross section that is circular, elliptical or emulates any one of the cross sections described in FIG. 12. The array of shafts 114 provides a barrier in front of the blades of the propeller 108 when rotating. The array of shafts 114 protects unsuspecting or unaware bystanders from contacting the propeller blades from the anterior of the aircraft 100.

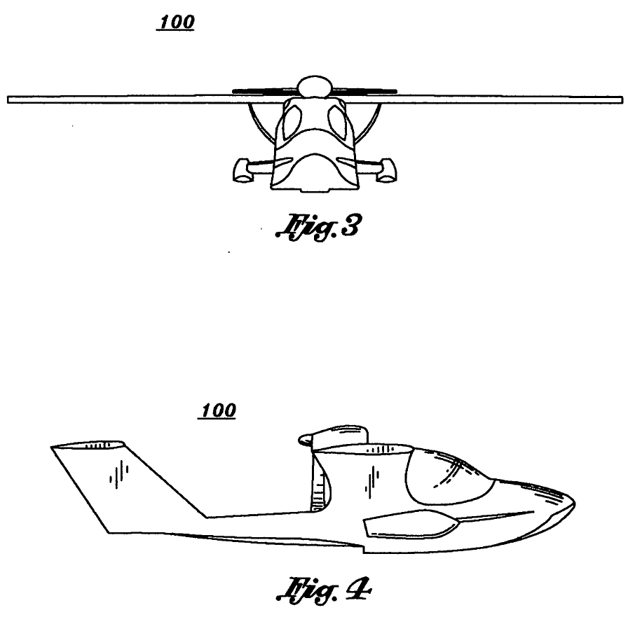

FIG. 2 is an illustration showing another angled view of the light sport aircraft 100 of FIG. 1. The propeller guard 102 is shown from a different angle that accentuates the cross-sectional shape of the propeller guard 102. FIG. 2 shows that the propeller guard 102 possesses an aerodynamic or airfoil cross-sectional shape, also known as a teardrop shape. Such a shape adds aerodynamic properties to the propeller guard 102, such as producing lift, reducing drag, or any combination of the two. An aerodynamic cross-sectional shape is not symmetrical so as to impose a certain force or property. In one embodiment of the present invention, the cross-sectional streamlined shape of the propeller guard 102 is designed not to create lift but to reduce drag. FIG. 12 is an illustration showing various aerodynamic cross-sectional shapes for the propeller guard 102, in one embodiment of the present invention.

The propeller guard 102, like the other members of the aircraft 100, can be composed of a variety of materials, such as commonly used aerospace composite material, metal, carbon fiver, Kevlar, aluminum, titanium, alloy, common aircraft alloy, aluminum-steel alloy or titanium welded alloy.

The propeller guard 102 can be a molded composite member that is coupled to the fixed wing 104 with a fastener such as one or more screws, nails, bolts or rivets. The propeller guard 102 can also be coupled to the fixed wing 104 with a liquid or semi-liquid glue or joint compound that dries after application. The propeller guard 102 can further be coupled with the fuselage 106 in a manner similar to the manner in which it is fastened to the fixed wing 104. In another embodiment of the present invention, a joint is created between the propeller guard 102 and the fixed wing 104 wherein a removable fastener secures the two members together. The propeller guard 102 can further be coupled with the fuselage 106 in a similar manner. In yet another embodiment of the present invention, the propeller guard 102 and the fixed wing 104 are molded or fabricated together as one integrated piece. The propeller guard 102 and the fuselage 106 can also be molded or fabricated together as one integrated piece.

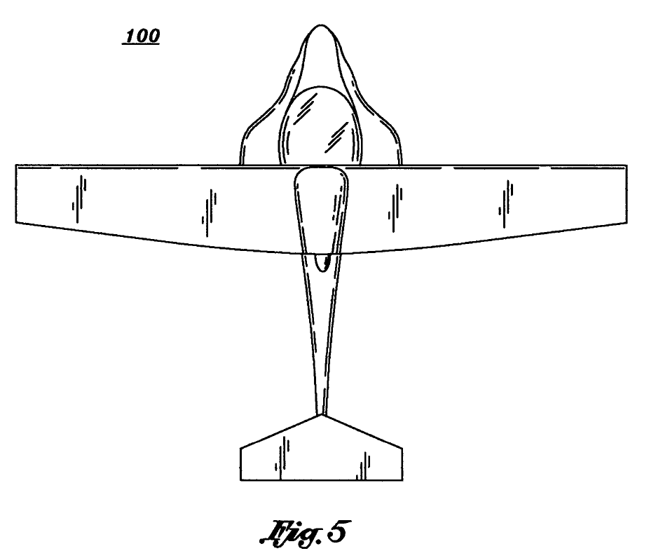

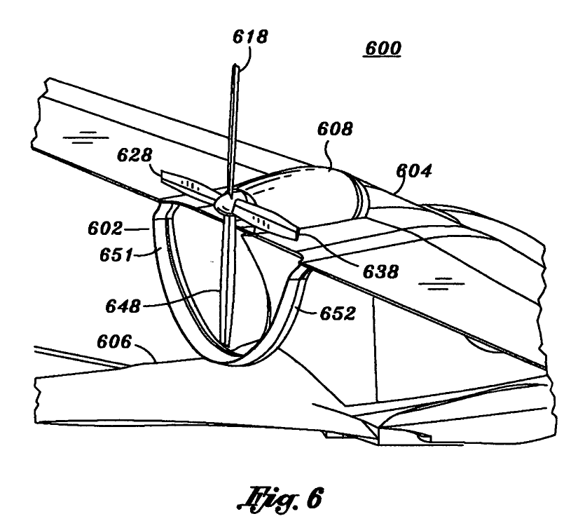

FIG. 3 is an illustration showing a frontal view of the aircraft 100 of FIG. 1. FIG. 4 is an illustration showing a side view of the aircraft 100 of FIG. 1. FIG. 5 is an illustration showing a top view of the aircraft 100 of FIG. 1.

FIG. 6 is a drawing showing a more detailed angled view of a propeller guard 602, in one embodiment of the present invention. FIG. 6 shows the aircraft 600 including a fixed wing 604 and a propeller 608 including propeller blades 618, 628, 638 and 648 that rotate. The fuselage 606 of the aircraft 600 is located under the fixed wing 604. A propeller guard 602 is coupled with the fixed wing 604 and the fuselage 606. As before, the propeller guard 602 comprises a semicircular strip or arc that is positioned outside at least a portion of the circular arc traveled by outer tips of the blades 618, 628, 638 and 648 of the propeller 608 when rotating.

In an embodiment of the present invention, the propeller guard 602 includes one or more lights. The lights may be located along the inside surface 651 or along the outside surface 652 of the propeller guard 602. The lights can be coupled to or fastened to the inside surface 651 or the outside surface 652 using a fastener or other securing means. Alternatively, the lights can be integrated into the inside surface 651 or the outside surface 652 of the propeller guard 602 during or after fabrication of the propeller guard 602.

The lights can be standard aircraft safety and/or signal lights. The viewable distance of the lights can vary from small distances of several feet to larger distances of several thousands of feet. The lights can be comprised of a standard bulb-type construction including a light bulb that rests within a powered receptacle and an external transparent or translucent protective housing that may also be diffractive. Alternatively, the lights can be comprised of Light Emitting Diodes (LEDs) coupled to a power source and an external transparent or translucent protective housing. The power source for the lights, including wires and other materials, can be integrated into the inside volume of the propeller guard 602.

The lights coupled to propeller guard 602 provide a visual reminder of caution to persons of the blades of the propeller 608 when rotating. The lights coupled to propeller guard 102 seek to warn people of the propeller blades when they are rotating. The lights coupled to propeller guard 602 further provide a visual warning to other aircraft of the dangerous nature of rotating propeller blades.

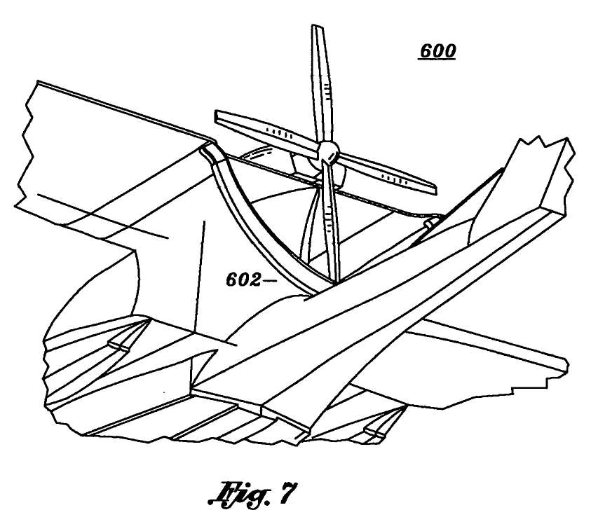

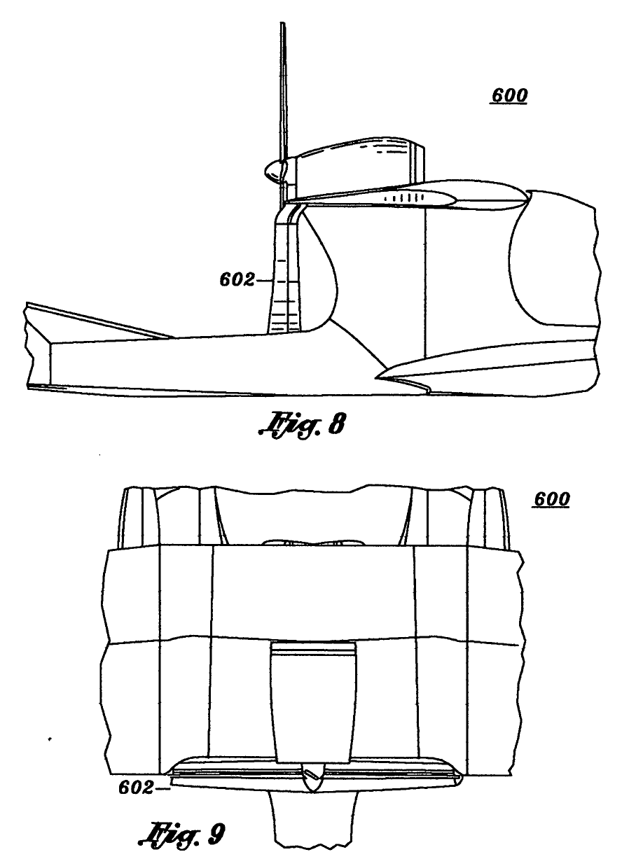

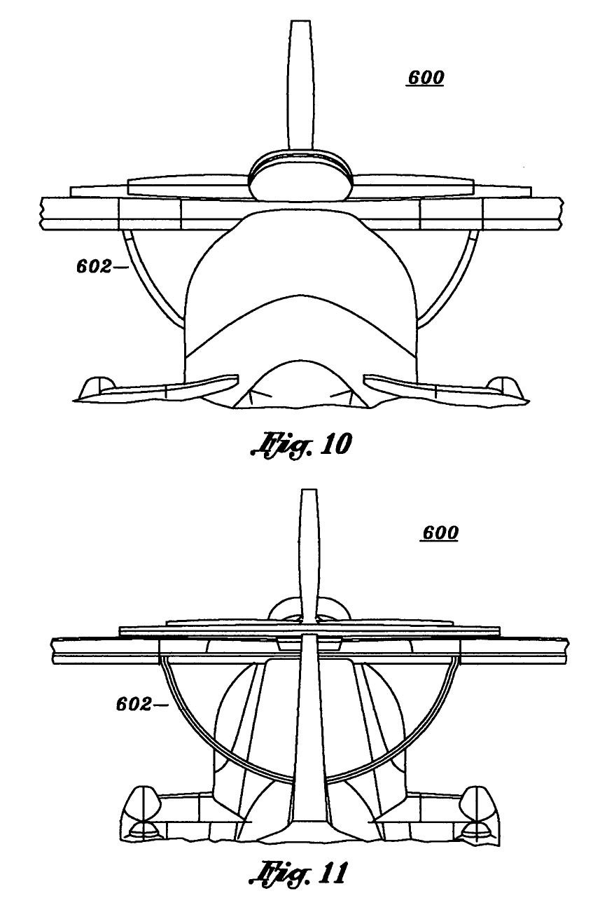

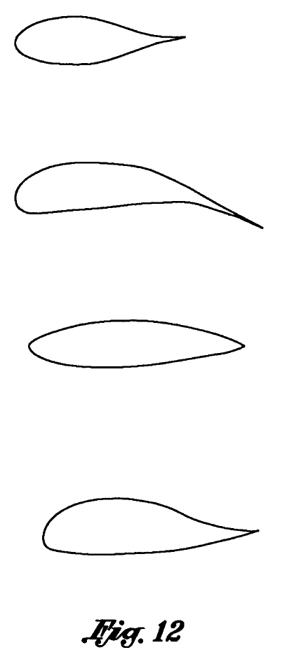

FIG. 7 is a drawing showing another angled view of the propeller guard 602 of FIG. 6. FIG. 8 is a drawing showing a side view of the propeller guard 602 of FIG. 6. FIG. 9 is a drawing showing a top view of the propeller guard 602 of FIG. 6. FIG. 10 is a drawing showing a frontal view of the propeller guard 602 of FIG. 6. FIG. 11 is a drawing showing a rear view of the propeller guard 602 of FIG. 6.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A safety device for a fixed wing aircraft, comprising:
a strip positioned around propeller blades.

2. The safety device of claim 1, wherein the strip has a circular shape.

3. The safety device of claim 2, wherein the strip has a cross-sectional airfoil shape.

4. The safety device of claim 1, wherein the strip is coupled with a fixed wing.

5. The safety device of claim 4, wherein the strip is coupled with any one of a trailing edge of the fixed wing and a leading edge of the fixed wing.

6. The safety device of claim 1, further comprising:
a light coupled with the strip.

7. The safety device of claim 1, further comprising:
a plurality of rods positioned in front of the propeller blades, wherein each of the plurality of rods is coupled on one end to the strip and on the other end to a fixed wing.

8. A safety device assembly for a fixed wing aircraft, comprising:
a propeller having blades that rotate; and
an arc positioned around the blades.

9. The safety device assembly of claim 8, wherein the arc has a cross-sectional airfoil shape.

10. The safety device assembly of claim 8, wherein the arc is coupled with a fixed wing.

11. The safety device assembly of claim 10, wherein the arc is coupled with any one of a trailing edge of the fixed wing and a leading edge of the fixed wing.

12. The safety device assembly of claim 8, further comprising:
a light coupled with the arc.

13. The safety device assembly of claim 8, further comprising:
a plurality of rods positioned in front of the blades, wherein each of the plurality of rods is coupled on end to the arc and on the other end to a fixed wing.

14. A safety device assembly for a fixed wing aircraft, comprising:
a propeller having blades that rotate; and
a strip positioned around at least part of a rotational path of outer tips of the blades when rotating.

15. The safety device assembly of claim 14, wherein the strip has a circular shape.

16. The safety device assembly of claim 15, wherein the strip has a cross-sectional airfoil shape.

17. The safety device assembly of claim 14, wherein the strip is coupled with a fixed wing.

18. The safety device assembly of claim 17, wherein the strip is coupled with any one of a trailing edge of the fixed wing and a leading edge of the fixed wing.

19. The safety device assembly of claim 14, further comprising:
a light coupled with the strip.

20. The safety device assembly of claim 19, wherein the light is integrated in a surface of the strip.
